(19) United States
(12) Patent Application Publication
(10) Pub. No.: US 2012/0281221 A1
(43) Pub. Date: Nov. 8, 2012

(54) PROCESS AND MEASURING EQUIPMENT FOR IMPROVING THE SIGNAL RESOLUTION IN GAS ABSORPTION SPECTROSCOPY

(75) Inventors: Michel STUDER, Luzern (CH); Andreas WITTMANN, Giswil (CH)

(73) Assignee: AXETRIS AG, Kagiswil (CH)

(21) Appl. No.: 13/460,950

(22) Filed: May 1, 2012

(30) Foreign Application Priority Data
May 2, 2011 (EP) 11 401 500.1

(51) Int. Cl. G01N 21/59

(52) U.S. Cl. 356/437

(57) ABSTRACT

Process and measuring equipment for improving the signal resolution in gas absorption spectroscopy, wherein the measuring equipment includes a laser light source, a light detector and a measuring chamber arranged in between, and furthermore a light source control unit and a light detector evaluation unit. To improve the signal resolution, the noise intensity of the measuring equipment is reduced by averaging over time the interfering signal portions caused by back-reflections, etalons respectively self-mixing effects. This is accomplished by a light modulator arranged downstream the laser light source that continuously periodically influences the optical path length of the light beam. Thereto the light modulator includes an optical element with an adjustable refractory index that continuously cyclically alters the phase of the laser light of the light beam.

### CROSS-REFERENCE TO RELATED APPLICATION

The present application claims priority under 35 USC §119 to European Patent Application No. 11 401 500.1 filed May 2, 2011, the entire disclosure of which is incorporated herein by reference.

### TECHNICAL FIELD OF THE INVENTION

The invention concerns a process for improving the signal resolution of measuring equipment for gas absorption spectroscopy where the measuring equipment comprises a laser light source and a light detector with an absorption section arranged in between that extends in a gas measuring volume containing the gas or gas mixture to be analyzed, and is equipped with a light source control unit for the laser light source and an evaluation unit for the light detector. In addition, the invention relates to measuring equipment for gas detection for the performance of the process for improving the signal resolution.

### DESCRIPTION OF THE RELATED ART

For a multitude of tasks in the sectors of safety, convenience, and environmental protection there is a great demand for cost-efficient, reliable, and highly sensitive gas sensors. With known gas sensors, the detection of gas is frequently accomplished by means of absorption spectroscopy. With this technology, a light beam with a specific wavelength that is absorbed by the particular gas to be detected for which the gas sensor is designed is passed through a gas or gas mixture. The degree of absorption of the light beam is then used as an indicator for the degree of concentration of the gas to be analyzed. With tunable diode laser absorption spectroscopy (TDLS) in particular, it is necessary in the interest of high detection sensitivity that the light beam emitted by the laser diode semiconductor chip exit from the laser diode with a minimum of interference phenomena. Even slight back-reflections of the light beam emitted by the laser light source caused by reflective surfaces of the housing or by optical elements cause a self-mixing of the light beam and/or etalon. Both effects generate optical noise that leads to a reduction of the signal resolution in high-resolution measuring equipment, especially in case of weak gas absorptions.

Prior art includes a number of processes and measuring equipment for improving the signal resolution in gas absorption spectroscopy. Sample citations include the publications DE 197 26 455A1, U.S. Pat. No. 6,002,702A, DE 297 24 019 U1, U.S. Pat. No. 4,934, 816, and U.S. Pat. No. 4,684,258. The solutions proposed in those publications reduce the interfering noise of the measuring equipment in question in different ways and with more or less technological input and, as a consequence, with varying success.

Starting with the prior art, the invention addresses the problem of proposing a solution for significantly improving the sensitivity of a gas sensor with the help of simple means for reducing the optical noise of the measuring equipment.

### SUMMARY OF THE INVENTION

According to the invention, this problem is solved by a process for improving the signal resolution, and by measuring equipment for performing this process each of which are described herein.

Generally, the detection sensitivity of a gas detector is determined by the chosen measuring process and the realized effective absorption path length related to this. Even the intensity noise of the laser light source itself represents a limit for the detection sensitivity of gas analysis processes. In order to measure the absorption line of gases, a tunable laser light source is preferably used. The simplest method is based on tuning the emission wavelength of the laser by changing the temperature because the emission wavelength of a semiconductor laser is temperature dependent. In the final analysis, the measuring value in gas absorption spectroscopy is the relative intensity change at the light detector that is caused by the absorption of the laser light by the gas molecules. This is described by the Lambert-Beer law.

When monochromatic laser light passes through a gas measuring volume containing absorbing gas, the intensity acting on the light detector is, in mathematically first approximation,

I_{T}≈I₀(1−αL).

Here, I_{T} designates the transmitted intensity, I₀ the initial beam intensity, α the absorption coefficient, and L the length of the absorption path. Superimposed on this intensity is an intensity change ΔI caused by etalons and optical feedback (self-mixing interferences) of the measuring equipment. This is described by the formula

ΔI=I_{T}−I₀=I₀A cos θ

where I₀ designates the intensity emitted by the laser light source, A the amount of the amplitude modulation, and θ the optical phase of the laser light while passing through the absorbing gas.

It is the basic idea of the invention to improve the signal resolution in gas absorption spectroscopy by averaging over time the intensity noise of the measuring equipment in accordance with the formula above by means of an adjustable light modulator that preferably influences cyclically the optical path length for the light beam.

The process for improving the signal resolution of measuring equipment for gas absorption spectroscopy according to the invention presupposes measuring equipment that comprises a laser light source and a light detector in between which the gas to be measured is disposed—for example in free state or in a measuring chamber—in a gas measuring volume for the gas detection. In addition, a light source control unit for the laser light source and an evaluation unit for the light detector are required. An optical absorption section extends as a path in a gas measuring volume with the gas or gas mixture to be analyzed, with the laser light source generating, in the wavelength tuning range of the laser, monochromatic laser light that is influenced by the gas or gas mixture to be analyzed along the absorption section.

In principle, the process for improving the signal resolution according to the invention includes the following steps:
Generation of a monochromatic light beam by means of the laser light source and the light source control unit that comprises monochromatic laser light whose laser light is at least partially absorbed in the gas measuring volume;
Passing the light beam through the gas measuring volume and through a light modulator that is arranged in front of, in, or behind the gas measuring volume and that adjustably influences the optical path length of the light beam along the absorption section;
Detection of the light beam after passing through the gas measuring volume and the light modulator by means of the light detector; and
Processing and evaluation of the detector signal of the light detector by means of the evaluation unit.

According to the invention, influencing the optical path length between the laser light source and the light detector is accomplished by means of the light modulator via the phase of the laser light. For this purpose, the light modulator comprises an optical element with a controllable refractory index. In order to change the phase of the laser light, the refractory index of the optical element is varied. Preferably, the adjustable refractory index of the optical element is continuously changed cyclically. The phase of the laser light changes accordingly. The variation of the refractory index can be accomplished by applying an electric voltage, for example to a liquid crystal, by impressing an electric current, by direct or indirect temperature change, by applying pressure or tension, or by applying electrical and/or magnetic fields, or in some other way, with the influence being either static or dynamic. It is also possible to use two or more of the measures listed above simultaneously for influencing the light beam. Preferably, the refractory index of an optical element of the light modulator is influenced electrically by means of a light modulator control unit.

For gas detection, the light beam emitted by the laser light source can be guided in a straight line once or twice through the gas measuring volume. In the first case, the laser light source and the light detector are arranged so that they face each other directly on different sides of the gas measuring volume. In the second case, they are usually arranged side by side on one side of the gas measuring volume, with the light beam coming from the laser light source being reflected in the direction of the light detector by a deflecting mirror provided on the opposite side of the gas measuring volume. A multiple deflection of the light beam in the gas measuring volume by means of an appropriate number of deflecting mirrors is also possible. Each reflection extends the optical path length of the light beam in the gas measuring volume, thereby increasing the possibility of an interaction of the laser light with the gas to be detected. Especially with low gas concentrations, this may lead to an amplification of the measuring signal of the light detector.

In a preferred embodiment of the invention, the light beam is guided through the gas measuring volume with multiple reflections. Preferably, no plane deflecting mirrors arranged on the outside of the gas measuring volume are used for this but rather walls that enclose or limit the gas measuring volume. The laser light may be deflected in a directed or a diffuse manner.

Due to the modulation of the optical path length, it is now possible to also work with gas measuring volumes that send much stray light back to the light detector. Without the modulation of the path length, the sensitivity due to interfering signals from self-mixing and/or etalon effects would be too strong. The use of a light modulator also makes it possible, for example, to use a porous gas-permeable block of material as the gas measuring volume in which the laser radiation, i.e. the light beam is reflected or scattered to a great extent. In general, the gas measuring volume must be implemented so that the light beam is able to enter the gas volume, penetrate it, and exit from it again. Specifically, this also applies to the gas-permeable block of material. The shape of the block of material can be chosen randomly, and the same applies, for example, also to a measuring chamber that encloses the gas measuring volume.

The stray light can be generated by the walls of the measuring chamber or by the pore walls of the gas-permeable block of material. It is diffuse and reaches the light detector after multiple deflection, i.e. the light beam extends not entirely in a straight line in the gas measuring volume but similar to a polygonal course consisting of straight path sections.

Preferably, by means of the light modulator, the phase of the laser light is continuously changed cyclically. For this purpose, advantageously, the refractory index of an optical element of the light modulator is influenced appropriately by means of a light modulator control unit.

Alternatively, the optical element of the light modulator may be arranged at an angle which, during the modulation of the refractory index, additionally leads to the modulation of the optical path length, to a modulation of the beam shift of the laser beam, which can be used for the averaging over time of such interference effects as may occur in a porous block of material.

Additionally, in one embodiment of the invention, the wavelength of the laser light of the laser light source is altered continuously or in predetermined steps. Here, the wavelength and/or the intensity of the laser light of the tunable laser light source can be modulated with a frequency f₀, for example, with the wavelength being varied over a possible absorption spectrum of a gas or gas mixture to be analyzed. Because the laser light interacts with the gas particles when passing through the gas to be measured, an interaction of the light beam with the gas particles occurs in the case of resonance, i.e. when the wavelength of the laser light coincides with the wavelength of a molecular absorption line of the gas particles. This interaction can be detected by a downstream light detector.

Specifically, the light modulator in the optical beam path of the measuring equipment for tunable optical laser spectroscopy permits a cyclical variation of the optical path length of the light beam from the laser light source to the light detector, especially in the light modulator. This is accomplished by the optical element of the light modulator whose refractory index can be altered in a controlled way, also in a continuously periodical way. The propagation rate of the laser light in the optical element depends on the currently selected light refractory index. It decreases with an increasing refractory index, and increases with a decreasing refractory index. In order to cover the same geometric path length from its entry to its exit from the light modulator, the laser light needs more time with a higher refractory index of the optical element than with a lower refractory index. This circumstance is described by the so-called optical path length. With a higher refractory index, and with the same geometric path length from the entry to the exit from the optical element, the optical path length is longer than with a smaller refractory index.

In principle, the light modulator may be arranged in any location of the optical absorption path between the laser light source and the light detector. It proved to be especially favorable to arrange the light modulator directly at the exit window or the laser aperture of the laser light source, and to preferably arrange the optical element there, and specifically to optically connect it directly with these. In this way, it is possible to prevent additional reflecting surfaces in the beam path of the light beam that might generate interfering back-reflections.

Preferably, the optical path length of the light beam is varied up to a multiple of the wavelength of the laser light by means of the optical element. The typical phase shift permits an efficient averaging over time of the intensity noise of the measuring equipment, and thereby a reduction of the interference signals during the detection of the absorption line by means of the light detector. This reduces the intensity noise of the measuring equipment significantly. For the light modulator, it is generally possible to use all types of optical elements whose refractory index can be periodically altered infinitely or in discrete steps and with suitable frequency by means of the light modulator control unit. Preferably, the frequency of the change of the refractory index is selected to be different from the frequency of the laser light for the gas detection.

In optics, the change of the refractory index of a medium is usually connected with a change of its optical density, i.e. the absorptivity of the medium. The portion of the light radiation that the medium allows to pass through is called degree of transmission. The attenuation of the light radiation by the medium is generally composed of absorption, scatter, deflection, and reflection, and is always dependent on the wavelength. Accordingly, the change of the refractory index of the optical element of the light modulator in the process according to the invention causes a change of intensity, specifically a continuous modulation of the intensity of the laser light of the light beam at the light detector, that may lead to a falsification of the measured results.

According to the invention, in one embodiment of the invention, provisions are made for the evaluation unit to compensate for the varying intensity reduction of the output measuring signal at the light detector that is caused by the continuous change of the refractory index of the optical element. In order to correct an output measuring signal “falsified” in such a way during the gas absorption, it is possible to use a series of attenuations of the light beam without absorbing gas that is recorded at different wavelengths, specifically at absorption wavelengths, and where the optical path length or the refractory index is modulated. Alternatively, such a series can also be recorded in the presence of gas as long as this only leads to a negligible absorption of the laser light. Preferably, the compensation of the intensity reduction during the gas detection is performed by scanning the measuring chamber with laser light of variable wavelength by means of previously determined measured values at certain discrete refractory indices of the modulator element. This makes it possible to use the advantage of the averaging over time of the intensity noise of the measuring equipment without falsifying the measuring result of the light detector. Alternatively, instead of a continuous phase shift, it is also possible to set discrete phase values, in which case a measured 2 f signal is normalized with the appropriate equal portion before averaging over various discrete phases takes place.

Special measuring equipment is proposed for performing the process described above for improving the signal resolution in measuring equipment for gas absorption spectroscopy. Like the equipment known from the prior art, the measuring equipment for gas detection according to the invention comprises a laser light source and a light detector that, relative to the gas to be measured that is contained in a gas measuring volume, are arranged relative to each other, for example on a measuring chamber for gas absorption spectroscopy, in such a way that a monochromatic light beam emanating from a laser light source reaches the light detector after passing through the gas measuring volume once or multiple times. As is common, the measuring equipment also comprises a light source control unit for the laser light source and an evaluation unit for the light detector. According to the invention, downstream from the laser light source, at least one light modulator for influencing the optical path length of the light beam is arranged that comprises an optical element with a variable refractory index or an optical element whose alignment relative to the light beam can be changed. For this purpose, the light modulator comprises a suitable light modulator control unit that acts on the optical element. The light modulator may be arranged in front of, in, or behind the gas to be measured.

In the measuring equipment, the path length can be established not only via a modulation of the refractory index but, for example, also by means of a transparent plate, for example a plane parallel glass plate or wedge plate, that rotates in the beam path. If the incidence of the laser deviates from the plate normal, the optical path lengthens continuously due to the longer geometric section in the plate. This implementation offers the additional advantage of minimal lateral displacement of the beam, resulting in an additional averaging of the interference patterns (speckles) on the detector that may be generated by the spatial coherence of the laser radiation.

In a preferred embodiment of the invention, the laser light source can be tuned by means of the light source control unit for adjusting the amplitude and/or the wavelength of the laser light of the light beam. Depending on the refractory index, the optical element of the light modulator continuously changes the phase of the laser light cyclically. Preferably, the optical element varies the optical path length of the light beam up to a multiple of the wavelength of the laser light, for example 0.5 to 7 times, typically 1 to 3 times, with the frequency of the cyclical change of the refractory index of the optical element preferably deviating from the modulation frequency of the laser light for the gas absorption.

Below, the invention is explained in detail with reference to embodiments shown schematically in the drawing. Additional characteristics of the invention are given in the following description of the embodiment of the invention in conjunction with the claims and the attached drawing. The individual characteristics of the invention may be realized either individually by themselves or in combinations of several in different embodiments of the invention.

### BRIEF DESCRIPTION OF THE DRAWINGS

FIG. 1 shows measuring equipment according to the invention where the optical path between the laser light source and the light detector is implemented as a straight line;

FIG. 2 shows measuring equipment according to the invention where the straight-line optical path between the laser light source and the light detector is folded.

### DETAILED DESCRIPTION OF THE INVENTION

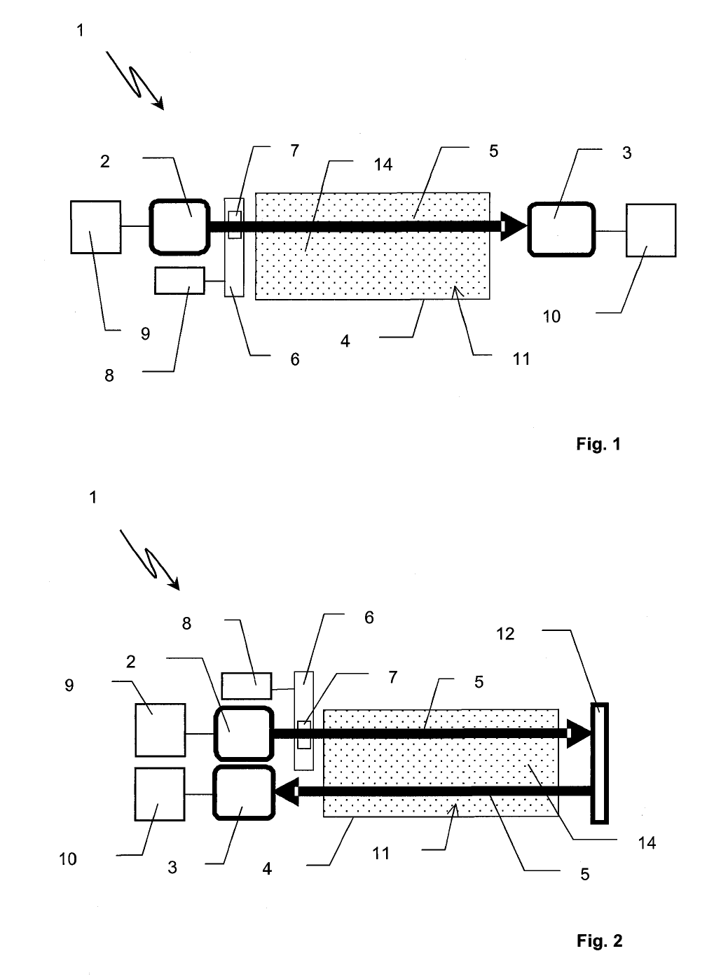

The FIGS. 1, 2 each show the measuring equipment 1 according to the invention that has a laser light source 2 and a light detector 3 that are arranged relative to each other, on a measuring chamber 4 for gas absorption spectroscopy, in such a way that a light beam 5 emanating from the laser light source 2 reaches the light detector 3 after passing through the gas measuring volume 14 once or twice. Immediately behind the laser light source 2, a light modulator 6 with an integrated optical element 7 is arranged in the beam path of the light beam 5 from the laser light source 2 to the light detector 3, with the optical element 7 consisting of a phase element. The refractory index of the optical element 7 can be adjusted variably by means of a light modulator control unit 8; specifically, it can be continuously altered in a cyclical way.

The laser light source 2 is controlled by a laser light control unit 9 that determines the amplitude and/or the wavelength of the laser light of the light beam 5. The light source control unit 9 can set the amplitude and/or the wavelength at a fixed value or modulate it over time; specifically, it can continuously tune the wavelength of the laser light in a cyclical way. The light detector 3 is connected with an evaluation unit 10 that processes and evaluates the output measuring signal of the light detector 3. The result of the evaluation can be displayed, stored, or printed out by means of devices not shown in the drawing.

Inside the measuring chamber 4, the gas measuring volume 14 contains gas particles 11 that absorb at least a portion of the laser light of the light beam 5. In the embodiment shown in FIG. 1, the optical path between the laser light source 2 and the light detector 3 is a straight line, while in the embodiment shown in FIG. 2 it is folded. This means that the light beam 3 in FIG. 1 crosses the measuring chamber 4 only once in a straight line, while crossing it twice in FIG. 2. In FIG. 1, the laser light source 2 and the light detector 3 are arranged diametrically opposed on different sides of the measuring chamber 4. If the laser light source 2 and the light detector 3 are arranged so that they are not directly opposed, a deflecting mirror 12 for the light beam 5 is provided that is arranged on the measuring chamber opposite from them and reflects the light beam 5 emanating from the laser light source 2 in the direction of the light detector 3.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A process for improving the signal resolution of measuring equipment for gas absorption spectroscopy that comprises a laser light source, a light detector, a light source control unit for the laser light source, an evaluation unit for the light detector and an absorption section arranged between the laser light source and the light detector that extends in a gas measuring volume containing the gas or gas mixture to be analyzed, wherein first a monochromatic light beam is generated by means of the laser light source and the light source control unit, wherein the light beam is then passed through the gas measuring volume and through at least one light modulator that is arranged in front of, in, or behind the gas measuring volume and controllably influences an optical path length of the light beam along the absorption path, wherein the light beam after its passage through the gas measuring volume and the light modulator is detected by means of the light detector, and wherein the detector signal of the light detector is then processed and evaluated by means of the evaluation unit, with the phase of the laser light of the light beam being preferably continuously altered in a cyclical way by means of the light modulator, wherein the purpose of altering the phase of the laser light the adjustable refractory index of the optical element of the light modulator is influenced.

2. The process according to claim 1, wherein the light beam is directed perpendicularly or at an angle at the light modulator and/or the optical element of the light modulator.

3. The process according to claim 1, wherein the light beam is guided in the gas measuring volume with multiple reflections.

4. The process according to claim 1, wherein the alignment of the light modulator and/or of the optical element in relation to the light beam varies, and is preferably continuously altered in a cyclical way.

5. The measuring equipment for gas detection, for performing the process for improving the signal resolution according to claim 1, wherein the measuring equipment comprises a laser light source and a light detector with an absorption section arranged in between that extends in a gas measuring volume containing the gas or gas mixture to be analyzed, and wherein the measuring equipment is equipped with a light source control unit for the laser light source and an evaluation unit for the light detector, and wherein a light beam emanating from the laser light source reaches the light detector after passing through the gas measuring volume at least once, and wherein between the laser light source and the light detector at least one light modulator with an optical element for influencing the optical path length of the light beam is arranged, and wherein the light modulator and/or the optical element of the light modulator extend perpendicularly or at an angle in relation to the light beam, wherein the light modulator comprises a light modulator control unit for the variable adjustment of the refractory index of the optical element that can preferably be continuously altered in a cyclical way.

6. The measuring equipment according to claim 5, wherein the laser light source can be tuned by means of the light source control unit for setting the amplitude and/or the wavelength of the laser light.

7. The measuring equipment according to claim 5, wherein the light modulator and/or the optical element of the light modulator extend perpendicularly or at an angle in relation to the light beam, and that by means of the light modulator control unit the alignment of the optical element in relation to the incident light beam can be adjusted variably, preferably be continuously altered in a cyclical way.
